(19) United States
(12) Patent Application Publication
(10) Pub. No.: US 2006/0031069 A1
(43) Pub. Date: Feb. 9, 2006

(54) System and method for performing a grapheme-to-phoneme conversion

(75) Inventors: Jun Huang, Fremont, CA (US); Gustavo Abrego, San Jose, CA (US); Lex S. Olorenshaw, Half Moon Bay, CA (US)

Correspondence Address: Gregory J. Koerner;Redwood Patent Law, 1291 East Hillsdale Boulevard, Suite 205, Foster City, CA, 94404, US

(73) Assignees: Sony Corporation; Sony Electronics Inc.

(21) Appl. No.: 10/910,383

(22) Filed: Aug. 3, 2004

(51) Int. Cl. G10L 15/06

(52) U.S. Cl. 704/243

(57) ABSTRACT

A system and method for performing a grapheme-to-phoneme conversion procedure includes a graphone model generator that performs a graphone model training procedure to produce an N-gram graphone model based upon dictionary entries in a training dictionary. A grapheme-to-phoneme decoder then references the N-gram graphone model to perform grapheme-to-phoneme decoding procedures to convert input text into corresponding output phonemes.

### BACKGROUND SECTION

1. Field of Invention

This invention relates generally to speech recognition and speech synthesis systems, and relates more particularly to a system and method for performing grapheme-to-phoneme conversion.

2. Description of the Background Art

Implementing efficient methods for manipulating electronic information is a significant consideration for designers and manufacturers of contemporary electronic devices. However, efficiently manipulating information with electronic devices may create substantial challenges for system designers. For example, enhanced demands for increased device functionality and performance may require more system processing power and require additional hardware resources. An increase in processing or hardware requirements may also result in a corresponding detrimental economic impact due to increased production costs and operational inefficiencies.

Furthermore, enhanced device capability to perform various advanced operations may provide additional benefits to a system user, but may also place increased demands on the control and management of various device components. For example, an enhanced electronic device that effectively handles and manipulates audio data may benefit from an effective implementation because of the large amount and complexity of the digital data involved.

Due to growing demands on system resources and substantially increasing data magnitudes, it is apparent that developing new techniques for manipulating electronic information is a matter of concern for related electronic technologies. Therefore, for all the foregoing reasons, developing effective systems for manipulating information remains a significant consideration for designers, manufacturers, and users of contemporary electronic devices.

### SUMMARY

In accordance with the present invention, a system and method are disclosed for efficiently performing a grapheme-to-phoneme conversion procedure. In one embodiment, during a graphone model training procedure, a training dictionary is initially provided that includes a series of vocabulary words and corresponding phonemes that represent pronunciations of the respective vocabulary words. A graphone model generator performs a maximum likelihood training procedure, based upon the training dictionary, to produce a unigram graphone model of unigram graphones that each include a grapheme segment and a corresponding phoneme segment.

In certain embodiments, a marginal trimming technique may be utilized to eliminate unigram graphones whose occurrence in the training dictionary are less than a certain pre-defined threshold. During marginal trimming, the pre-defined threshold may gradually increase from an initial, relatively small value to a relatively larger value during each iteration of the training procedure.

Next, the graphone model generator utilizes alignment information from the training dictionary to convert the unigram graphone model into optimally aligned sequences by performing a maximum likelihood alignment procedure. The graphone model generator may then calculate probability values for each unigram graphone in light of corresponding context information to thereby convert the optimally aligned sequences into a final N-gram graphone model.

In a grapheme-to-phoneme conversion procedure, input text may initially be provided to a grapheme-to-phoneme decoder in any effective manner. A first stage of the grapheme-to-phoneme decoder then accesses the foregoing N-gram graphone model for performing a grapheme segmentation procedure upon the input text to thereby produce an optimal word segmentation of the input text. A second stage of the grapheme-to-phoneme decoder then performs a search procedure with the optimal word segmentation to generate corresponding output phonemes that represent the original input text.

In certain embodiments, the grapheme-to-phoneme decoder may also perform various appropriate types of postprocessing upon the output phonemes. For example, in certain embodiments, the grapheme-to-phoneme decoder may perform a phoneme format conversion procedure upon output phonemes. Furthermore, the grapheme-to-phoneme decoder may perform stress processing in order to add appropriate stress or emphasis to certain of the output phonemes. In addition, the grapheme-to-phoneme decoder may generate appropriate syllable boundaries for the output phonemes.

In accordance with the present invention, a memory-efficient, statistical data-driven approach is therefore implemented for grapheme-to-phoneme conversion. The present invention provides a dynamic programming procedure that is formulated to estimate the optimal joint segmentation between training sequences of graphemes and phonemes. A statistical language model (N-gram graphone model) is trained to model the contextual information between grapheme and phoneme segments.

A two-stage grapheme-to-phoneme decoder then efficiently recognizes the most-likely phoneme sequences in light of the particular input text and N-gram graphone model. For at least the foregoing reasons, the present invention therefore provides an improved system and method for efficiently performing a grapheme-to-phoneme conversion procedure.

### BRIEF DESCRIPTION OF THE DRAWINGS

FIG. 1 is a block diagram for one embodiment of an electronic device, in accordance with the present invention;

FIG. 2 is a block diagram for one embodiment of the memory of FIG. 1, in accordance with the present invention;

FIG. 3 is a block diagram for one embodiment of the grapheme-to-phoneme module of FIG. 2, in accordance with the present invention;

FIG. 4 is a block diagram of a graphone, in accordance with one embodiment of the present invention;

FIG. 5 is a diagram for an N-gram graphone, in accordance with one embodiment of the present invention;

FIG. 6 is a block diagram for the N-gram graphone model of FIG. 2, in accordance with one embodiment of the present invention;

FIG. 7 is a diagram illustrating a graphone model training procedure, in accordance with one embodiment of the present invention; and

FIG. 8 is a diagram illustrating a grapheme-to-phoneme decoding procedure, in accordance with one embodiment of the present invention.

### DETAILED DESCRIPTION

The present invention relates to an improvement in speech recognition and speech synthesis systems. The following description is presented to enable one of ordinary skill in the art to make and use the invention, and is provided in the context of a patent application and its requirements. Various modifications to the embodiments disclosed herein will be apparent to those skilled in the art, and the generic principles herein may be applied to other embodiments. Thus, the present invention is not intended to be limited to the embodiments shown, but is to be accorded the widest scope consistent with the principles and features described herein.

The present invention comprises a system and method for efficiently performing a grapheme-to-phoneme conversion procedure, and includes a graphone model generator that performs a graphone model training procedure to produce an N-gram graphone model based upon dictionary entries in a training dictionary. A grapheme-to-phoneme decoder may then reference the foregoing N-gram graphone model for performing grapheme-to-phoneme decoding procedures to convert input text into corresponding output phonemes.

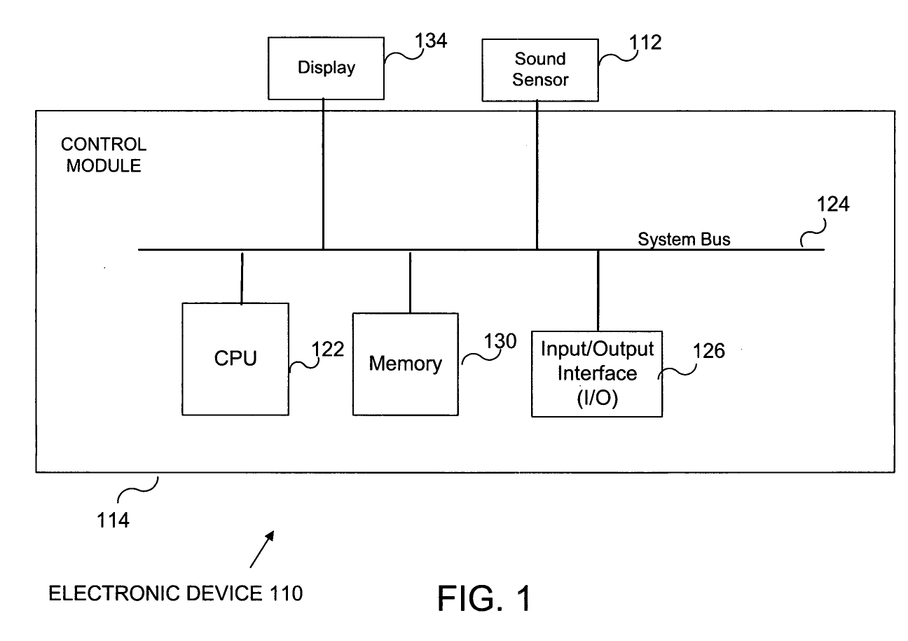

Referring now to FIG. 1, a block diagram for one embodiment of an electronic device 110 is shown, according to the present invention. The FIG. 1 embodiment includes, but is not limited to, a sound sensor 112, a control module 114, and a display 134. In alternate embodiments, electronic device 110 may readily include various other elements or functionalities in addition to, or instead of, certain elements or functionalities discussed in conjunction with the FIG. 1 embodiment.

In accordance with certain embodiments of the present invention, electronic device 110 may be embodied as any appropriate electronic device or system. For example, in certain embodiments, electronic device 110 may be implemented as a computer device, a consumer electronics device, a personal digital assistant (PDA), a cellular telephone, a television, a game console, or as part of entertainment robots such as AIBO™ and QRIO™ by Sony Corporation.

In the FIG. 1 embodiment, electronic device 110 utilizes sound sensor 112 to detect and convert ambient sound energy into corresponding audio data. The captured audio data is then transferred over system bus 124 to CPU 122, which responsively performs various processes and functions with the captured audio data, in accordance with the present invention.

In the FIG. 1 embodiment, control module 114 includes, but is not limited to, a central processing unit (CPU) 122, a memory 130, and one or more input/output interface(s) (I/O) 126. Display 134, CPU 122, memory 130, and I/O 126 are each coupled to, and communicate, via common system bus 124. In alternate embodiments, control module 114 may readily include various other components in addition to, or instead of, certain of those components discussed in conjunction with the FIG. 1 embodiment.

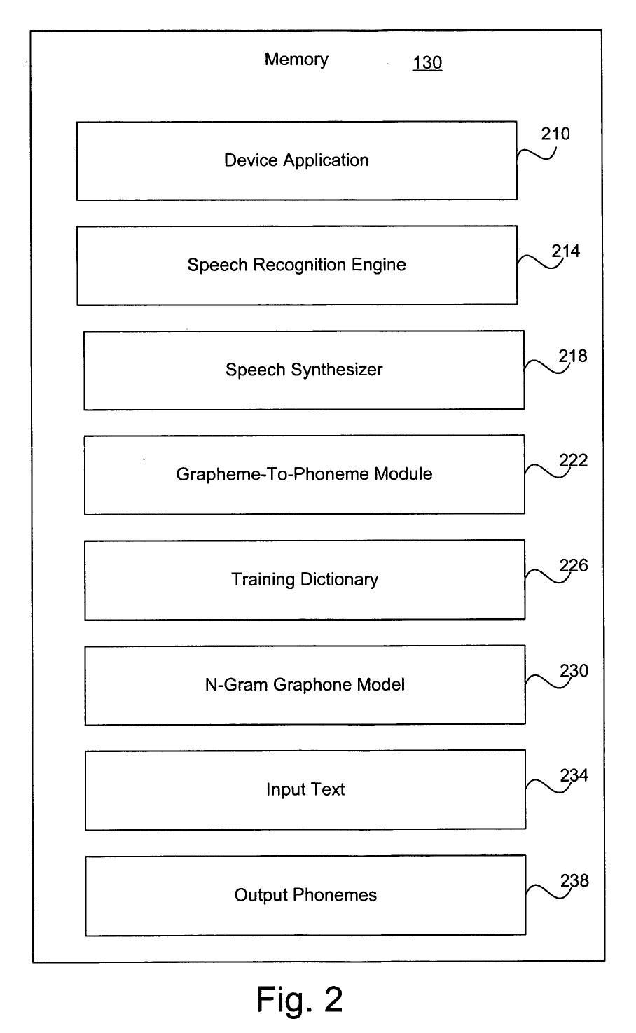

In the FIG. 1 embodiment; CPU 122 is implemented to include any appropriate microprocessor device. Alternately, CPU 122 may be implemented using any other appropriate technology. For example, CPU 122 may be implemented as an application-specific integrated circuit (ASIC) or other appropriate electronic device. In the FIG. 1 embodiment, I/O 126 provides one or more effective interfaces for facilitating bi-directional communications between electronic device 110 and any external entity, including a system user or another electronic device. I/O 126 may be implemented using any appropriate input and/or output devices. For example, I/O 126 may include a keyboard device for entering input text to electronic device 110. The functionality and utilization of electronic device 110 are further discussed below in conjunction with FIG. 2 through FIG. 8.

Referring now to FIG. 2, a block diagram for one embodiment of the FIG. 1 memory 130 is shown according to the present invention. Memory 130 may comprise any desired storage-device configurations, including, but not limited to, random access memory (RAM), read-only memory (ROM), and storage devices such as floppy discs or hard disc drives. In the FIG. 2 embodiment, memory 130 stores a device application 210, a speech recognition engine 214, a speech synthesizer 218, a grapheme-to-phoneme module 222, a training dictionary 226, an N-gram graphone model 230, input text 234, and output phonemes 238. In alternate embodiments, memory 130 may readily store various other elements or functionalities in addition to, or instead of, certain elements or functionalities discussed in conjunction with the FIG. 2 embodiment.

In the FIG. 2 embodiment, device application 210 includes program instructions that are executed by CPU 122 (FIG. 1) to perform various functions and operations for electronic device 110. The particular nature and functionality of device application 210 typically varies depending upon factors such as the type and particular use of the corresponding electronic device 110.

In the FIG. 2 embodiment, speech recognition engine 214 includes one or more software modules that are executed by CPU 122 to analyze and recognize input sound data. In certain embodiments, speech recognition engine 214 may utilize grapheme-to-phoneme module 222 to dynamically create entries for a speech recognition dictionary used for speech recognition procedures. In the FIG. 2 embodiment, speech synthesizer 218 includes one or more software modules that are executed by CPU 122 to generate speech with electronic device 110. In certain embodiments, speech recognition engine 214 must utilize grapheme-to-phoneme module 222 for converting input text 234 into output phonemes 238 for performing speech synthesis procedures.

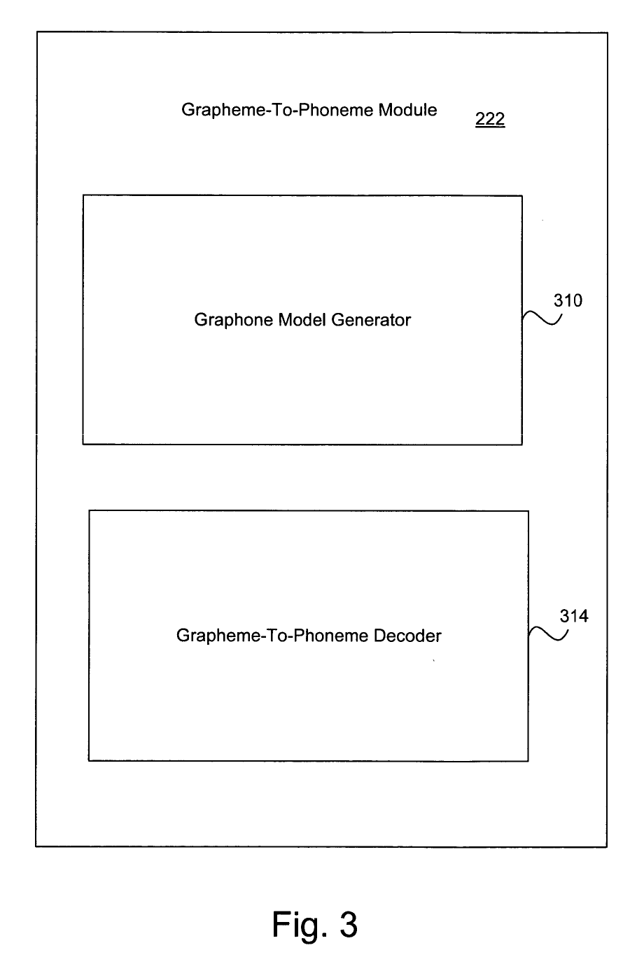

In the FIG. 2 embodiment, grapheme-to-phoneme module 222 analyzes training dictionary 226 to create an N-gram graphone model 230 during a graphone model training procedure. Graphone-to-phoneme module 222 may then utilize the N-gram graphone model 230 to perform grapheme-to-phoneme decoding procedures for converting input text 234 into corresponding output phonemes 238. The implementation and utilization of grapheme-to-phoneme module 222 are further discussed below in conjunction with FIGS. 3-8.

Referring now to FIG. 3, a block diagram for one embodiment of the FIG. 2 grapheme-to-phoneme module 222 is shown in accordance with the present invention. Grapheme-to-phoneme module 222 includes, but is not limited to, a graphone model generator 310 and a grapheme-to-phoneme decoder 314. In alternate embodiments, grapheme-to-phoneme module 222 may readily include various other elements or functionalities in addition to, or instead of, certain elements or functionalities discussed in conjunction with the FIG. 3 embodiment.

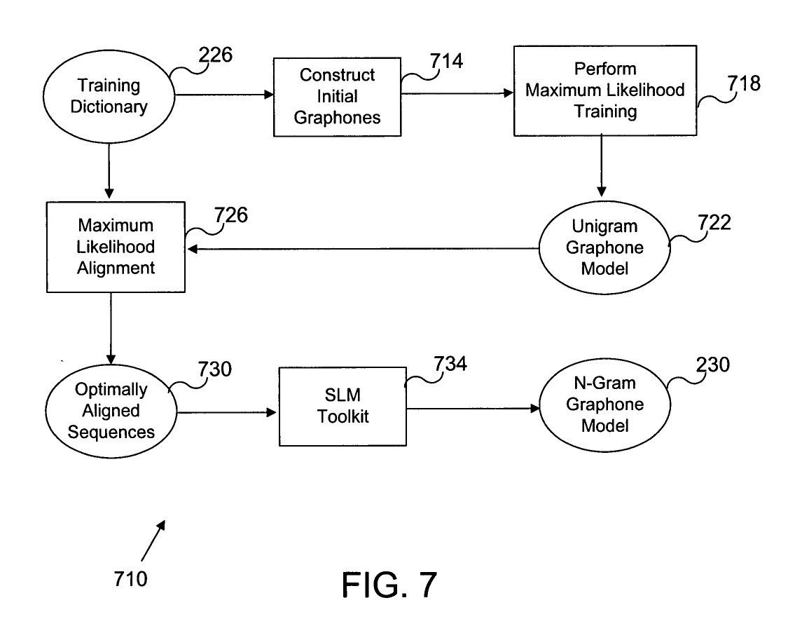

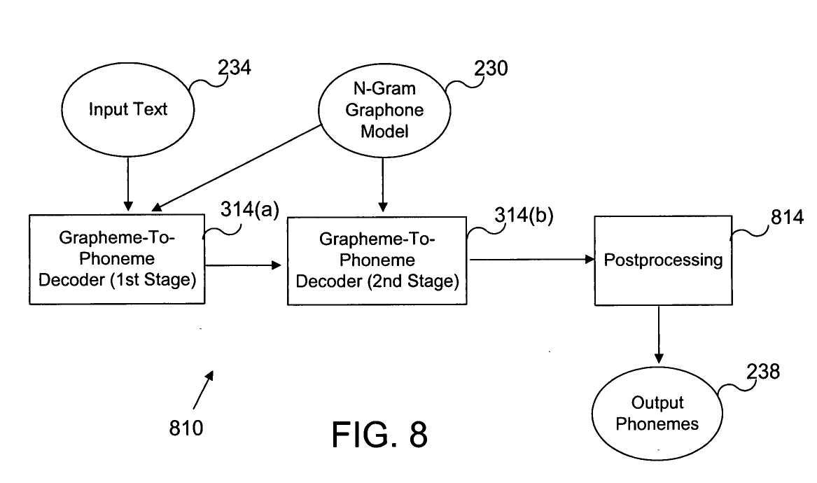

In the FIG. 3 embodiment, electronic device 110 may utilize graphone model generator 310 to perform a graphone model training procedure to create an N-gram graphone model 230 (FIG. 2). In addition, in the FIG. 3 embodiment, electronic device 110 may utilize grapheme-to-phoneme decoder 314 to perform a grapheme-to-phoneme decoding procedure to convert input text 234 into corresponding output phonemes 238 (FIG. 2). Graphone model generator 310 is further discussed below in conjunction with FIG. 7. Grapheme-to-phoneme decoder 314 is further discussed below in conjunction with FIG. 8.

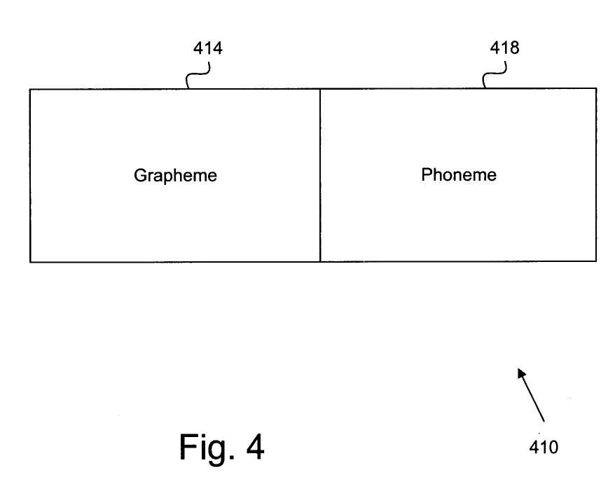

Referring now to FIG. 4, a block diagram of a graphone 410 is shown in accordance with one embodiment of the present invention. In the FIG. 4 embodiment, graphone 410 includes a grapheme 414 and a corresponding phoneme 418. In alternate embodiments, the present invention may utilize graphones that include elements or configurations in addition to, or instead of, certain elements or configurations discussed in conjunction with the FIG. 4 embodiment.

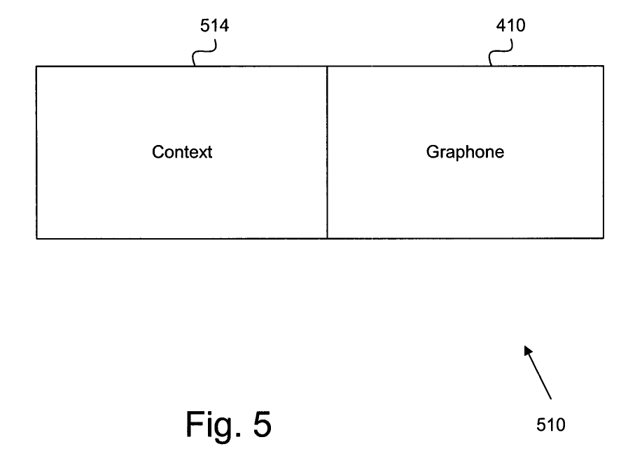

In the FIG. 4 embodiment, graphone 410 is implemented as a grapheme-phoneme joint multigram. In the FIG. 4 embodiment, grapheme 414 is formed of one or more letters, and phoneme 418 is a phoneme set formed of one or more phones that correspond to the particular grapheme 414. Graphone 410 therefore may be described as a pair that is comprised of a letter segment (grapheme 414) and a phoneme segment (phoneme 418) of possibly different lengths. For example, the word rough and its corresponding phonetic pronunciation /r ah f/ can be represented by a set of three graphones 410, i.e., [r, r], [ou, ah], and [gh, f]. The utilization of various graphones 410 by the present invention is further discussed below in conjunction with FIGS. 5-8.

Referring now to FIG. 5, a block diagram of an N-gram graphone 510 is shown in accordance with one embodiment of the present invention. In the FIG. 5 embodiment, N-gram graphone 510 includes a graphone 410 and a corresponding context 514. In alternate embodiments, the present invention may utilize N-gram graphones that include elements or configurations in addition to, or instead of, certain elements or configurations discussed in conjunction with the FIG. 5 embodiment.

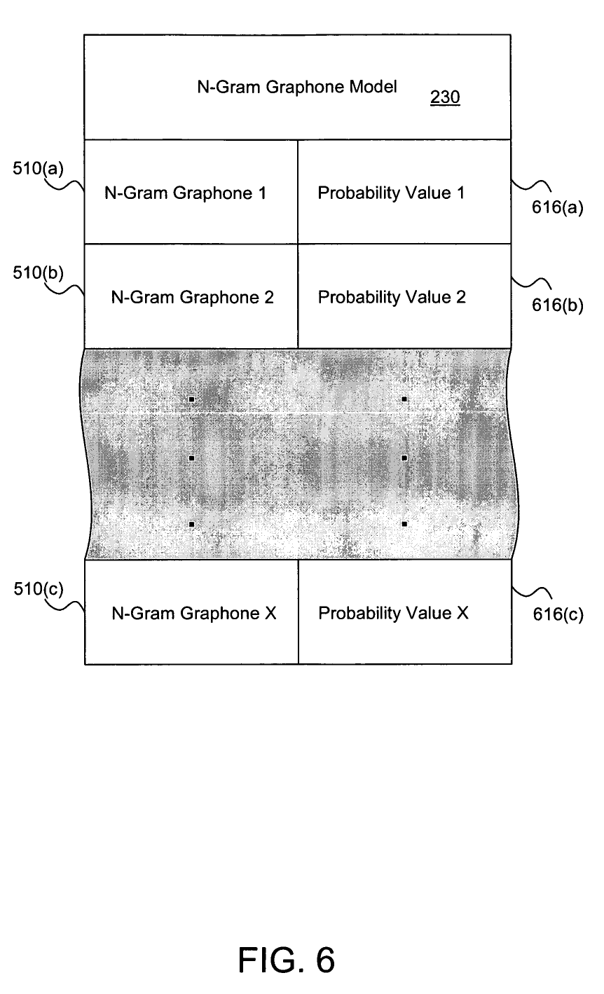

In the FIG. 5 embodiment, an N-gram graphone 510 may be described as a current graphone 410 preceded by a context 514 of one or more consecutive preceding graphones. In the FIG. 5 embodiment, the context 514 may be derived from analyzing and observing the same pattern in training dictionary 226 (FIG. 2). The N-gram length “N” is a variable value that may be selected according to various design considerations. For example, a 3-gram would include a current graphone 410 and two consecutive preceding context graphones. The utilization of N-gram graphones 510 to create an N-gram graphone model 230 is further discussed below in conjunction with FIG. 6.

Referring now to FIG. 6, a block diagram for one embodiment of the FIG. 2 N-gram graphone model 230 is shown in accordance with the present invention. In alternate embodiments, N-gram graphone model 230 may readily include various other elements or functionalities in addition to, or instead of, certain elements or functionalities discussed in conjunction with the FIG. 6 embodiment.

In the FIG. 6 embodiment, N-gram graphone model 230 includes an N-gram graphone 1 (510(a)) through an N-gram graphone X (510(c)). N-gram graphone model 230 may be implemented to include any desired number of N-gram graphones 510 that may include any desired type of information. In the FIG. 6 embodiment, each N-gram graphone 510 is associated with a corresponding probability value 616 that expresses the likelihood that a current graphone 410 from a particular N-gram graphone 510 would be preceded by the corresponding context 514 from that same N-gram graphone 510. In certain embodiments, probability values 616 are derived from analyzing training dictionary 226. The foregoing probability values are proportional to the frequency with which each N-gram graphone 510 is observed in training dictionary 226.

In the FIG. 6 embodiment, N-gram graphone 1 (510(a)) corresponds to probability value 1 (616(a)), N-gram graphone 2 (510(b)) corresponds to probability value 2 (616(b)), and N-gram graphone X (510(c)) corresponds to probability value X (616(c)). The probability values 616 therefore incorporate context information (context 514 of FIG. 5) for the corresponding current graphones 410. The creation and utilization of N-gram graphone model 230 is further discussed below in conjunction with FIGS. 7-8.

Referring now to FIG. 7, a diagram illustrating a graphone model training procedure 710 is shown according to one embodiment of the present invention. The FIG. 7 embodiment is presented for purposes of illustration, and in alternate embodiments, the present invention may perform graphone model training procedures that include various other steps or functionalities in addition to, or instead of, certain steps or functionalities discussed in conjunction with the FIG. 7 embodiment.

In the FIG. 7 embodiment, a training dictionary 226 (FIG. 2) is initially provided that includes a series of vocabulary words and corresponding phonemes that represent pronunciations of the respective vocabulary words. A graphone model generator 310 (FIG. 3) may analyze the training dictionary 226 to construct a set of initial graphones 714 that pair graphemes 414 from training dictionary 226 with corresponding phonemes 418.

The graphone model generator 310 then performs a maximum likelihood training procedure 718 to convert the initial graphones 714 into a unigram graphone model 722. In certain embodiments, with regard to training of unigram graphone model 722, a set of training grapheme sequences and a set of training phoneme sequences may be defined with the following formulas:

$$\begin{matrix}G ≡ {\{ {\vec{g}}_{i} \}}_{i = 1}^{N} \text{:} set of training grapheme sequences \\ Φ ≡ {\{ {\vec{ϕ}}_{i} \}}_{i = 1}^{N} \text{:} set of training phoneme sequences \end{matrix}$$

where N denotes the number of entries in training dictionary 226.

In certain embodiments, an (m,n) graphone model may be defined as a graphone model in which the longest size of sequences in G and Φ are m and n, respectively. For example, a (4, 1) graphone model means that one grapheme with up to 4 letters may be grouped with only a single phoneme to form graphones 410 (FIG. 4).

In certain embodiments, a joint segmentation or alignment of \vec{g}ᵢ and \vec{φ}ᵢ may be expressed by the following formula:

$$\begin{matrix}{\vec{q}}_{t} = ( {q}_{1} , {q}_{2} , … , {q}_{L} ) = ( [ {\tilde{g}}_{1} , {\tilde{φ}}_{1} ] , [ {\tilde{g}}_{2} , {\tilde{φ}}_{2} ] , … , [ {\tilde{g}}_{L} , {\tilde{φ}}_{L} ] ) \\ where \text{:} & ( 1 ) \\ \{ \begin{matrix}( {\tilde{g}}_{1 ,} {\tilde{g}}_{2} , … , {\tilde{g}}_{L} ) = {\vec{g}}_{i} \\ ( {\tilde{φ}}_{1 ,} {\tilde{φ}}_{2} , … , {\tilde{φ}}_{L} ) = {\vec{φ}}_{i}\end{matrix} & ( 2 )\end{matrix}$$

qⱼ≡[\tilde{g}ⱼ, \tilde{φ}ⱼ], j=1,2, . . . , L are the graphones.

In certain embodiments, a unigram (m,n) graphone model parameter set Λ* may be estimated using a maximum likelihood (ML) criterion expressed by the following formula:

$${Λ}^{*} = {arg max}_{{\vec{q}}_{t} ∈ S ( {\vec{g}}_{i} , {\vec{φ}}_{i} )} p ( {\vec{q}}_{t} \vert Λ ) \qquad ( 3 )$$

where S(\vec{g}ᵢ, \vec{φ}ᵢ) is a set of all possible joint segmentations of \vec{g}ᵢ and \vec{φ}ᵢ. The parameter set Λ* may be trained using an expectation-maximization (EM) algorithm. The EM algorithm is implemented using a forward-backward technique to avoid an exhaustive search of all possible joint segmentations of graphone sequences. In addition, in certain embodiments, a marginal trimming technique may be utilized to eliminate unigram graphones whose likelihoods are less than a certain pre-defined threshold. During marginal trimming, the pre-defined threshold may gradually increase from an initial relatively small value to a relatively larger value during each iteration of the training procedure.

In the FIG. 7 embodiment, graphone model generator 310 may next utilize alignment information from training dictionary 226 to convert unigram graphone model 722 into optimally aligned sequences 730 by performing a maximum likelihood alignment procedure 726. In certain embodiments, after the unigram graphone model Λ* (722) is obtained, for each (\vec{g}ᵢ, \vec{φ}ᵢ)ε(G,Φ), i=1,2, . . . , N, an optimal alignment may be computed by using an ML criterion that may be expressed by the following formula:

$${{\vec{q}}_{i}}^{*} = {arg max}_{{\vec{q}}_{t} ∈ S ( {\vec{g}}_{i} , {\vec{φ}}_{i} )} p ( {\vec{q}}_{t} \vert {Λ}^{*} ) \qquad ( 4 )$$

An optimal graphone sequence \vec{q}ᵢ* actually denotes an optimal joint segmentation (alignment) between a grapheme sequence \vec{g}ᵢ and a corresponding phoneme sequence \vec{φ}ᵢ, given a current trained unigram graphone model 722.

In the FIG. 7 embodiment, graphone model generator 310 may then calculate probability values 616 (FIG. 6) to convert optimally aligned sequences 730 into a final N-gram graphone model 230. In certain embodiments, after an optimal joint-segmentation of grapheme and phoneme sequences is produced as optimally aligned sequences 730, the N-gram graphone model 230 is constructed to model contextual information (context 514 of FIG. 5) between grapheme-phoneme sequences. For example, the grapheme ough can be pronounced as /ah f/, /uw/, and /ow/, as in words rough, through, and thorough, respectively, depending on the context.

In certain embodiments, a Cambridge/CMU statistical language model (SLM) toolkit 734 may be utilized to train N-gram graphone model 230. Priority levels for deciding between different backoff paths for exemplary tri-gram graphones are listed below in Table 1.

TABLE 1
List of different backoff paths for a tri-gram graphone model.

| Priority | Approximation |
|---|---|
| 5 | P(C \| A, B) |
| 4 | P(C \| B) * BO₂(A, B) |
| 3 | P(C) * BO₁(B) * BO₂(A, B) |
| 2 | P(C \| B) |
| 1 | P(C) * BO₁(B) |

As an example to illustrate the particular notation used in Table 1, a probability “P” of a graphone “C” occurring with a preceding context of “A,B” is expressed by the notation P(C|A, B) In Table 1, priority 5 is the highest priority level and priority 1 is the lowest priority level. In Table 1, BO₂(A,B) and BO₁(B) denote backoff weights (BOₓ) of a tri-gram and a bi-gram, respectively. Backoff values are an estimation of an unknown value (such as a probability value) based upon other related known values. In the grapheme-to-phoneme decoding procedure discussed below in conjunction with FIG. 8, grapheme-to-phoneme decoder 314 looks for an existing approximation of those N-grams having the highest priority level. The utilization of N-gram graphone model 230 in efficiently performing a grapheme-to-phoneme decoding procedure is further discussed below in conjunction with FIG. 8.

Referring now to FIG. 8, a diagram illustrating a grapheme-to-phoneme decoding procedure 810 is shown, according to one embodiment of the present invention. The FIG. 8 embodiment is presented for purposes of illustration, and in alternate embodiments, the present invention may perform grapheme-to-phoneme decoding procedures that include various other steps or functionalities in addition to, or instead of, certain steps or functionalities discussed in conjunction with the FIG. 8 embodiment.

In the FIG. 8 embodiment, input text 234 may initially be provided to electronic device 110 in any effective manner. A first stage 314(a) of grapheme-to-phoneme decoder 314 (FIG. 3) may then access N-gram graphone model 230 (generated above in FIG. 7) for performing a grapheme segmentation procedure upon input text 234 to thereby produce an optimal word segmentation of input text 234. A second stage 314(b) of grapheme-to-phoneme decoder 314 (FIG. 3) may then perform a stack search procedure with the optimal word segmentation in light of N-gram graphone model 230 to thereby generate output phonemes 238.

In the FIG. 8 embodiment, grapheme-to-phoneme decoder 314 searches for those phoneme sequences that maximize a joint probability of graphone sequences given orthography sequence \vec{g} according to a formula:

$${\vec{φ}}_{\vec{g}}^{*} = {arg max}_{{\vec{q}}_{t} ∈ S ( {\vec{g}}_{i} , {\vec{φ}}_{i} ) , {φ}_{t} ∈ {S}_{p} ( \vec{g} )} p ( {\vec{q}}_{t} \vert {Λ}_{ng} ) \qquad ( 5 )$$

where ^{S}ₚ(\vec{g}) denotes all possible phoneme sequences generated by \vec{g}, and Λ_{ng} denotes N-gram graphone model 230.

A joint probability of a graphone sequence in light of N-gram graphone model 230 can approximately be computed according to the following formula:

$$p ( {\vec{q}}_{t} ) = p ( {q}_{1} … {q}_{L} ) = {\prod }_{i = 1}^{L} p ( {q}_{i} \vert {q}_{1} … {q}_{i - 1} ) \approx {\prod }_{i = 1}^{L} p ( {q}_{i} \vert {q}_{i - n + 1} … {q}_{i - 1} ) \qquad ( 6 )$$

In accordance with the present invention, a fast, two-stage stack search technique determines an optimal pronunciation (output phonemes 238) given the criterion described above in Eq. (5).

In the FIG. 8 embodiment, for an input orthography sequence \vec{g} (input text 234), the first stage 314(a) of grapheme-to-phoneme decoder 314 searches for the most likely grapheme segmentation of the input text 234 in N-gram graphone model 230. First stage 314(a) of grapheme-to-phoneme decoder 314 seeks to find a segmentation having the furthest depth, while also complying with the backoff priority levels defined above in Table 1.

In the FIG. 8 embodiment, let us define depth i as the current number of grapheme segments, and \vec{g}_{i+1, i+2, . . . i+n} as the N-gram grapheme sub-sequences at current depth i. Let us further define gsᵢ as a stack containing all possible grapheme segments at current depth i. Then, in the FIG. 8 embodiment, the operation of the first stage 314(a) of grapheme-to-phoneme decoder 314 may be summarized with the following pseudo-code procedure:
while (not_end_of word) do
   construct all possible valid n-gram grapheme sequences \vec{g}_{i+1, i+2, . . . i+n} based on the elements of previous stacks and n-gram graphone model
if (p(gᵢ₊ₙ|gᵢ₊₁ . . . , gᵢ₊ₙ₋₁) exists) then
   push \vec{g}_{i+1, i+2, . . . i+n} into gsᵢ
else
   search for backoff paths with the priorities described in table 1; construct the new valid backoff n-gram
   grapheme sequences, and push them into gsᵢ. i++;

As one example of the foregoing segmentation procedure, consider the word “thoughtfulness”. An optimal segmentation after the operation of first stage 314(a) of grapheme-to-phoneme decoder 314, for a (4,1) graphone model with a 3-gram SLM, is given by the segmentation {th, ough, t, f, u, l, n, e, ss}.

In the FIG. 8 embodiment, given the foregoing optimal grapheme sequences, the second stage 314(b) of grapheme-to-phoneme decoder 314 may then search N-gram graphone model 230 for the optimal phoneme sequences that will maximize a joint probability of the graphone sequences defined above in Eq. (6). Let us define n_{seg} as the number of grapheme segments in the foregoing optimal phoneme sequences, and n_{g} as the order of N-gram. Let us further define \vec{g}ᵢ as the i^{th} N-gram grapheme in the grapheme stack, and \vec{φ}ᵢⱼ as all possible N-gram phoneme sequences for grapheme \vec{g}ᵢ. Furthermore, qᵢⱼ denotes a graphone 410 constructed by grapheme \vec{g}ᵢ and phoneme sequence \vec{φ}ᵢⱼ, and psᵢ denotes the stack of current phoneme candidates at depth i.

Then, in the FIG. 8 embodiment, the operation of the second stage 314(b) of grapheme-to-phoneme decoder 314 may be summarized with the following pseudo-code procedure:

for i [symbol] 1 to n_{seg} do

construct \vec{g}ᵢ = {gᵢ₋ₙ_{_{g}}+1,...,gᵢ}
find all possible \vec{φ}ᵢⱼ from Λₙ_{_{g}}, construct q ᵢⱼ
for k [symbol] 1 to | \vec{φ}ᵢⱼ | do

for l [symbol] 1 to n do

insert new phoneme token into ps ᵢ

for each q_{i+1,k} allowed to follow q ᵢⱼ do

update the graphone stack and the likelihood
of each graphone sequence in the stack

if psᵢₗ is unique then

pop out psᵢₗ

else

pop out the phoneme candidate with highest
likelihood in the graphone stack;
prune the stack

Let us assume an average length of the word orthography and the average number of phoneme mappings for each grapheme are M and N, respectively. For each input word in input text 234, the number of possible grapheme segmentations is exponential to the word length. Furthermore, each grapheme can map to multiple phoneme entries in the pronunciation space, with different likelihoods. As a result, the computing and storage cost for a direct solution of the search problem defined in Eq. (5) is on the order of O(c₁^{M})*O(c₂^{N}).

On the other hand, the operation of first stage 314(a) of grapheme-to-phoneme decoder 314 only requires O(M) number of operations. Furthermore, the operation of the second stage 314(b) of grapheme-to-phoneme decoder 314 requires O(Nⁿ^{_{g}}) operations, which is a non-deterministic polynomial (NP) problem. One feature of the two-stage grapheme-to-phoneme decoder 314 is that it reduces a two-dimensional exponential search problem into two one-dimensional NP search problems, while still keep the approximate optimization of Eq. (6).

In the FIG. 8 embodiment, grapheme-to-phoneme decoder 314 may also perform various appropriate types of postprocessing 814 upon output phonemes 238. For example, in certain embodiments, grapheme-to-phoneme decoder 314 may perform a phoneme format conversion procedure upon output phonemes 238. Furthermore, grapheme-to-phoneme decoder 314 may perform stress processing in order to add appropriate stress or emphasis to certain of output phonemes 238. In addition, grapheme-to-phoneme decoder 314 may generate appropriate syllable boundaries in output phonemes 238.

In accordance with the present invention, a memory-efficient, statistical data-driven approach is therefore implemented for grapheme-to-phoneme conversion. The present invention provides a dynamic programming (DP) procedure that is formulated to estimate the optimal joint segmentation between training sequences of graphemes and phonemes. A statistical language model (N-gram graphone model 230) is trained to model the contextual information between grapheme 414 and phoneme 418 segments. A two-stage grapheme-to-phoneme decoder 314 then efficiently recognizes the most-likely phoneme sequences given input text 234 and N-gram graphone model 230. For at least the foregoing reasons, the present invention therefore provides an improved system and method for efficiently performing a grapheme-to-phoneme conversion procedure.

The invention has been explained above with reference to certain preferred embodiments. Other embodiments will be apparent to those skilled in the art in light of this disclosure. For example, the present invention may readily be implemented using configurations and techniques other than those described in the embodiments above. Additionally, the present invention may effectively be used in conjunction with systems other than those described above as the preferred embodiments. Therefore, these and other variations upon the foregoing embodiments are intended to be covered by the present invention, which is limited only by the appended claims.

What is claimed is:

1. A system for performing a grapheme-to-phoneme conversion procedure, comprising:
a graphone model generator that performs a graphone model training procedure to produce an N-gram graphone model based upon dictionary entries in a dictionary; and
a grapheme-to-phoneme decoder that references said N-gram graphone model to perform said grapheme-to-phoneme decoding procedure to convert input text into output phonemes.

2. The system of claim 1 wherein a speech synthesizer utilizes said grapheme-to-phoneme decoder for converting said input text into said output phonemes during a speech synthesis procedure.

3. The system of claim 1 wherein a speech recognizer utilizes said grapheme-to-phoneme decoder for converting said input text into said output phonemes for dynamically implementing recognition dictionary entries for performing speech recognition procedures.

4. The system of claim 1 wherein said dictionary includes a series of dictionary entries that each have a text vocabulary word and a corresponding phoneme representation for a pronunciation of said text vocabulary word.

5. The system of claim 1 wherein said N-gram graphone model includes a series of N-gram graphones and corresponding respective probability values, said N-gram graphones including respective unigram graphones and corresponding context information, said corresponding respective probability values expressing likelihoods that said unigram graphones and said corresponding context are observed in said dictionary.

6. The system of claim 5 wherein said unigram graphones each include one or more letters and one or more phonemes corresponding to a pronunciation of said one or more letters.

7. The system of claim 6 wherein said graphone model generator creates said N-gram graphone model according to a pre-defined grapheme limitation and a pre-defined phoneme limitation, said pre-defined grapheme limitation specifying a first maximum total for said one or more letters, said pre-defined phoneme limitation specifying a second maximum total for said one or more phonemes.

8. The system of claim 1 wherein said graphone model generator performs a maximum likelihood training procedure to generate a unigram graphone model by observing occurrences of unigram graphones in said dictionary.

9. The system of claim 8 wherein said graphone model generator utilizes a expectation-maximization algorithm to perform said maximum likelihood training procedure to generate said unigram graphone model.

10. The system of claim 8 wherein said graphone model generator utilizes a marginal trimming technique during said maximum likelihood training procedure to trim infrequently observed ones of said unigram graphones from said unigram graphone model.

11. The system of claim 8 wherein said graphone model generator performs a maximum likelihood alignment procedure upon said unigram graphone model to produce optimally-aligned graphone sequences by observing graphone alignment characteristics in said dictionary.

12. The system of claim 11 wherein said graphone model generator calculates probability values corresponding to said optimally-aligned graphone sequences by observing graphone sequence characteristics in said dictionary to produce said N-gram graphone model.

13. The system of claim 1 wherein said graphone model generator includes a first stage decoder and a second stage decoder to sequentially perform said grapheme-to-phoneme decoding procedure.

14. The system of claim 1 wherein said graphone model generator includes a first stage decoder to perform a word segmentation procedure upon said input text to produce an optimal word segmentation.

15. The system of claim 14 wherein said first stage decoder performs said word segmentation procedure upon said input text by statistically analyzing segmentation characteristics of said input text according to said N-gram graphone model.

16. The system of claim 14 wherein said first stage decoder of said grapheme-to-phoneme decoder utilizes pre-defined backoff priority levels to select said optimal word segmentation during said word segmentation procedure.

17. The system of claim 14 wherein a second stage decoder of said grapheme-to-phoneme decoder performs a stack search procedure upon said optimal word segmentation by referencing said N-gram graphone model to identify said output phones.

18. The system of claim 1 wherein said grapheme-to-phoneme decoder performs a post-processing procedure upon said output phonemes, said post-processing procedure including a format conversion procedure.

19. The system of claim 1 wherein said grapheme-to-phoneme decoder performs a post-processing procedure upon said output phonemes, said post-processing procedure including a stress processing procedure.

20. The system of claim 1 wherein said grapheme-to-phoneme decoder performs a post-processing procedure upon said output phonemes, said post-processing procedure including a syllable generation procedure.

21. A method for performing a grapheme-to-phoneme conversion procedure, comprising:
performing a graphone model training procedure with a graphone model generator to produce an N-gram graphone model based upon dictionary entries in a dictionary; and
referencing said N-gram graphone model with a grapheme-to-phoneme decoder to perform said grapheme-to-phoneme decoding procedure to convert input text into output phonemes.

22. The method of claim 21 wherein a speech synthesizer utilizes said grapheme-to-phoneme decoder to convert said input text into said output phonemes during a speech synthesis procedure.

23. The method of claim 21 wherein a speech recognizer utilizes said grapheme-to-phoneme decoder to convert said input text into said output phonemes to dynamically implement recognition dictionary entries to perform speech recognition procedures.

24. The method of claim 21 wherein said dictionary includes a series of dictionary entries that each have a text vocabulary word and a corresponding phoneme representation for a pronunciation of said text vocabulary word.

25. The method of claim 21 wherein said N-gram graphone model includes a series of N-gram graphones and corresponding probability values, said N-gram graphones including respective unigram graphones and corresponding context information, said corresponding respective probability values expressing likelihoods that said unigram graphones and said corresponding context are observed in said dictionary.

26. The method of claim 25 wherein said unigram graphones each include one or more letters and one or more phonemes corresponding to a pronunciation of said one or more letters.

27. The method of claim 26 wherein said graphone model generator creates said N-gram graphone model according to a pre-defined grapheme limitation and a pre-defined phoneme limitation, said pre-defined grapheme limitation specifying a first maximum total for said one or more letters, said pre-defined phoneme limitation specifying a second maximum total for said one or more phonemes.

28. The method of claim 21 wherein said graphone model generator performs a maximum likelihood procedure to generate a unigram graphone model by observing occurrences of unigram graphones in said dictionary.

29. The method of claim 28 wherein said graphone model generator utilizes a expectation-maximization algorithm to perform said maximum likelihood procedure to generate said unigram graphone model.

30. The method of claim 28 wherein said graphone model generator utilizes a marginal trimming technique during said maximum likelihood procedure to trim infrequently observed ones of said unigram graphones from said unigram graphone model.

31. The method of claim 28 wherein said graphone model generator performs a maximum likelihood alignment procedure upon said unigram graphone model to produce optimally-aligned graphone sequences by observing graphone alignment characteristics in said dictionary.

32. The method of claim 31 wherein said graphone model generator calculates probability values corresponding to said optimally-aligned graphone sequences by observing graphone sequence characteristics in said dictionary to produce said N-gram graphone model.

33. The method of claim 21 wherein said graphone model generator includes a first stage decoder and a second stage decoder to sequentially perform said grapheme-to-phoneme decoding procedure.

34. The method of claim 21 wherein said graphone model generator includes a first stage decoder to perform a word segmentation procedure upon said input text to produce an optimal word segmentation.

35. The method of claim 34 wherein said first stage decoder performs said word segmentation procedure upon said input text by statistically analyzing segmentation characteristics of said input text according to said N-gram graphone model.

36. The method of claim 34 wherein said first stage decoder of said grapheme-to-phoneme decoder utilizes pre-defined backoff priority levels when selecting said optimal word segmentation during said word segmentation procedure.

37. The method of claim 34 wherein a second stage decoder of said grapheme-to-phoneme decoder performs a stack search procedure upon said optimal word segmentation by referencing said N-gram graphone model to identify said output phones.

38. The method of claim 21 wherein said grapheme-to-phoneme decoder performs a post-processing procedure upon said output phonemes, said post-processing procedure including a format conversion procedure.

39. The method of claim 21 wherein said grapheme-to-phoneme decoder performs a post-processing procedure upon said output phonemes, said post-processing procedure including a stress processing procedure.

40. The method of claim 21 wherein said grapheme-to-phoneme decoder performs a post-processing procedure upon said output phonemes, said post-processing procedure including a syllable generation procedure.

41. A system for performing a grapheme-to-phoneme conversion procedure, comprising:
means for performing a graphone model training procedure to produce an N-gram graphone model based upon dictionary entries in a dictionary; and
means for referencing said N-gram graphone model to perform said grapheme-to-phoneme decoding procedure to convert input text into output phonemes.
